(19) United States
(12) Patent Application Publication
(10) Pub. No.: US 2005/0056960 A1
(43) Pub. Date: Mar. 17, 2005

(54) Forming homogeneous mixtures of organic materials for physical vapor deposition using melting

(75) Inventors: Syamal K. Ghosh, Rochester, NY (US); Donn B. Carlton, Hamlin, NY (US); Tukaram K. Hatwar, Penfield, NY (US)

Correspondence Address: Thomas H. Close;Patent Legal Staff, Eastman Kodak Company, 343 State Street, Rochester, NY, 14650-2201, US

(73) Assignee: Eastman Kodak Company

(21) Appl. No.: 10/663,636

(22) Filed: Sep. 16, 2003

(51) Int. Cl. B29B 7/02; B29B 7/84; B29B 9/00

(52) U.S. Cl. 264/102; 264/118; 264/122; 264/349

(57) ABSTRACT

A method for forming homogeneous mixtures of powders of organic materials, which include, at least one dopant component and one host component, to provide a homogenous mixture for use in thermal physical vapor deposition to produce an organic layer on a substrate for use in an organic light-emitting device. The method includes, combining organic materials having at least one dopant component and one host component to form a mixture of organic materials and placing the mixture of organic materials in a container and sealing the container. The method further includes, heating and mixing the organic materials until they are melted, to form a homogeneous mixture of organic materials. Solidifying the homogeneous mixture of organic materials and removing the solidified homogeneous mixture of organic materials from the container.

### CROSS REFERENCE TO RELATED APPLICATIONS

Reference is made to commonly assigned U.S. patent application Ser. No. 09/898,369 filed Jul. 3, 2001 entitled “Method of Handling Organic Material in Making An Organic Light-Emitting Device” by Van Slyke et al.; U.S. patent application Ser. No. 10/073,690 filed Feb. 11, 2002, entitled “Using Organic Materials in Making An Organic Light-Emitting Device” by Ghosh et al., U.S. patent application Ser. No. 10/195,947 filed Jul. 16, 2002, entitled “Compacting Moisture-Sensitive Organic Material in Making An Organic Light-Emitting Device” by Ghosh et al., U.S. patent application Ser. No. 10/226,600 filed Aug. 23, 2002, entitled “Solid Compacted Pellet of Organic Material for Vacuum Deposition of OLED displays and Method of Making Same” by Ghosh et al., and U.S. patent application Ser. No. 10/348,118 filed Jan. 17, 2003, entitled “Using Compacted Organic Materials In Making White Light-emitting OLEDS” by Ghosh et al., U.S. patent application Ser. No. ______ filed concurrently herewith, entitled “Forming Homogeneous Mixtures of Organic Materials For Physical Vapor Deposition Using a Solvent” by Ghosh et al, U.S. patent application Ser. No. ______ filed concurrently herewith, entitled “Forming Homogeneous Mixtures of Organic Materials For Physical Vapor Deposition Using Dry Mixing” by Ghosh et al, and U.S. patent application Ser. No. ______ filed concurrently herewith, entitled “Forming Homogeneous Mixtures of Organic Materials For Physical Vapor Deposition Using Wet Mixing” by Ghosh et al, the teachings of which are incorporated herein.

### FIELD OF THE INVENTION

The present invention relates to forming homogeneous mixtures of two or more organic powder components for use in making an organic layer by physical vapor deposition on a substrate, which will form a part of an OLED display.

### BACKGROUND OF THE INVENTION

An organic light-emitting diode (OLED), also referred to as an organic electroluminescent device, can be constructed by sandwiching two or more organic layers between first and second electrodes.

Organic materials, thickness of vapor-deposited organic layers, and layer configurations, useful in constructing an organic light-emitting device are described for example, in commonly assigned U.S. Pat. Nos. 4,356,429; 4,539,507; 4,720,432; and 4,769,292, the disclosures of which are herein incorporated by reference.

Organic materials useful in making OLED displays, for example organic hole-transporting materials, organic light-emitting materials with an organic dopant, and organic electron-transporting materials can have relatively complex molecular structures with relatively weak molecular bonding forces, so care must be taken to avoid decomposition of the organic material during physical vapor deposition.

The aforementioned organic materials are synthesized to a relatively high degree of purity, and are provided in the form of powders, flakes, or granules. Such powders or flakes have been used heretofore for placement into a physical vapor deposition source wherein heat is applied for forming a vapor by sublimation or vaporization of the organic powder, the vapor condensing on a substrate to provide an organic layer thereon. In order to form a layer having more than one organic component, such as a host and a dopant component, it is desirable to co-evaporate simultaneously from two adjacent sources so that the organic components are mixed in the vapor-state prior to forming a layer on a substrate.

The co-evaporation process has several disadvantages which include (a) the vapor deposition chamber must be large to accommodate the evaporation sources for both the dopant and host component organic materials; (b) the large chambers necessary to complete co-evaporation are costly; (c) the larger the chamber, the more time that is required to reduce the pressure of the chamber prior to vaporization; and (d) each evaporation source containing a host or dopant component material must be vaporized by an independent power source, thereby increasing the cost of the co-evaporation process.

The rate of vaporization of each individual deposition source is crucial because that determines the chemical composition of the deposited organic layer on the substrate. In other words, the deposition rate determines the amount of vapor deposited on a substrate for a given length of time. Since the weight percentage of the dopant component in organic layers is lower than that of the host component, it is imperative that the deposition rate for the dopant component be adjusted accordingly. If the rate of vaporization of individual sources is not precisely controlled, the chemical composition of the vapor deposited on the substrate will be different from what is required to form a highly efficient OLED display.

Several problems associated with co-evaporation of organic powders, flakes or granules have also been discovered. Such problems include:
(i) powders, flakes, or granules are difficult to handle because they can acquire electrostatic charges via a process referred to as triboelectric charging;
(ii) powders, flakes, or granules of organic materials generally have a relatively low physical density (expressed in terms of weight per unit volume) in an approximate range from 0.05 to 0.2 g/cm³, compared to a physical density of an idealized solid organic material of approximately 1 g/cm³;
(iii) powders, flakes, or granules of organic materials have an undesirably low thermal conductivity, particularly when placed in a physical vapor deposition source which is disposed in a chamber evacuated to pressures as low as 10⁻⁶ Torr. Consequently, powder particles, flakes, or granules are heated only by radiative heating from a heated source, and by conductive heating of particles or flakes directly in contact with heated surfaces of the source. Powder particles, flakes, or granules which are not in contact with heated surfaces of the source are not effectively heated by conductive heating due to a relatively low particle-to-particle contact area; and
(iv) powders, flakes, or granules typically have a high ratio of surface area/volume and a correspondingly high propensity to entrap air and moisture between particles under ambient conditions. Consequently, a charge of organic powders, flakes, or granules loaded into a physical vapor deposition source, which is disposed in a chamber must be thoroughly outgased by preheating the source once the chamber has been evacuated to a reduced pressure.

If outgasing is omitted or is incomplete, particulate can be ejected from the evaporation source during the physical vapor deposition process. An OLED, having multiple organic layers, can become functionally inoperative if such layers include particles or particulates. Compaction of organic powders for making OLED displays using a physical vapor deposition method is described by Van Slyke et al. in a commonly assigned U.S. Patent Application Publication No. 2003/0008071 A1, the disclosure of which is incorporated herein by reference.

Organic powders, flakes, or granules can lead to nonuniform heating of such organic materials in physical vapor deposition sources with attendant spatially nonuniform vaporization of organic material, which can, result in potentially nonuniform vapor-deposited organic layers formed on a structure.

### SUMMARY OF THE INVENTION

It is an object of the present invention to provide efficient methods of mixing organic materials adaptable for making on organic layer on a structure, which will form a part of an OLED display.

It is another object of the present invention to provide a homogeneous mixture of organic materials including at least one host component and at least one dopant component adaptable for making an organic layer on a structure, which will form a part of an OLED display.

These objects are achieved in the present invention by providing a method for forming homogeneous mixture of powders of organic materials including at least one dopant component and one host component for use in thermal physical vapor deposition to produce an organic layer on a substrate for use in an organic light-emitting device, comprising:
a) combining organic materials, such materials including at least one dopant component and one host component to form a mixture of organic materials;
b) placing the mixture of organic materials in a container;
c) sealing the container;
d) heating the organic materials in the container until the organic materials are melted;
e) mixing the organic materials to form a homogeneous mixture of organic materials;
f) solidifying the homogeneous mixture of organic materials; and
g) removing the solidified homogeneous mixture of organic materials from the container.

The present invention provides another method for forming homogeneous mixture of powders of organic materials including at least one dopant component and one host component for use in thermal physical vapor deposition to produce an organic layer on a substrate for use in an organic light-emitting device, comprising:
a) combining organic materials in a powder form having at least one host component and one donor component to form a mixture of organic materials;
b) placing the mixture of organic materials in an open ended container;
c) placing the open ended container inside a vacuum furnace;
d) heating the organic materials inside the vacuum furnace until they are melted;
e) mixing the organic materials to form a homogeneous mixture of organic materials.
f) solidifying the homogeneous mixture of organic materials;
g) removing the solidified homogeneous mixture of organic materials from the open ended container; and
h) pulverizing the solidified homogeneous mixture of organic materials into a homogeneous mixture of organic powder suitable for thermal physical vaporization to produce an organic layer on a substrate for use in an organic light-emitting device.

A feature of the present invention is that melting of organic materials during the mixing process drives off all the gaseous and volatile contents that are present as impurities in the organic powders.

Another feature of the present invention is that the pulverized granules of the organic mixtures achieved by melting constitute strongly bonded host and dopant components of the organic molecules.

Another feature of the present invention is an effective way to provide homogeneous mixtures of organic materials that can be vaporized from a single source thereby avoiding the problems associated with co-evaporation of single component materials.

Another feature of the present invention is that compacted pellets can be formed from homogenous mixtures of organic materials thereby avoiding the problems associated with vaporization of organic powders, flakes or granules.

Another feature of the present invention is that a compacted pellet formed from a homogeneous mixture of organic materials can be evaporated for a longer duration from a single evaporation source rather than co-evaporation from a multiple evaporation sources as in single component materials.

### BRIEF DESCRIPTION OF THE DRAWINGS

FIG. 1 shows a schematic flowchart of mixing organic materials by melting in a vacuum oven or in an evacuated ampoule.

The term “powder” is used herein to denote a quantity of individual particles, which can be flakes, granules, or mixtures of varied particles and shapes comprising single or plurality of molecular species.

### DETAILED DESCRIPTION OF THE INVENTION

The organic layers of an OLED display include an organic or organo-metallic material that produces light, known as electroluminescence (EL), as a result of electron-hole recombination in the layer. Hereinafter, the term “organic” will be taken to include both purely organic as well as organo-metallic materials.

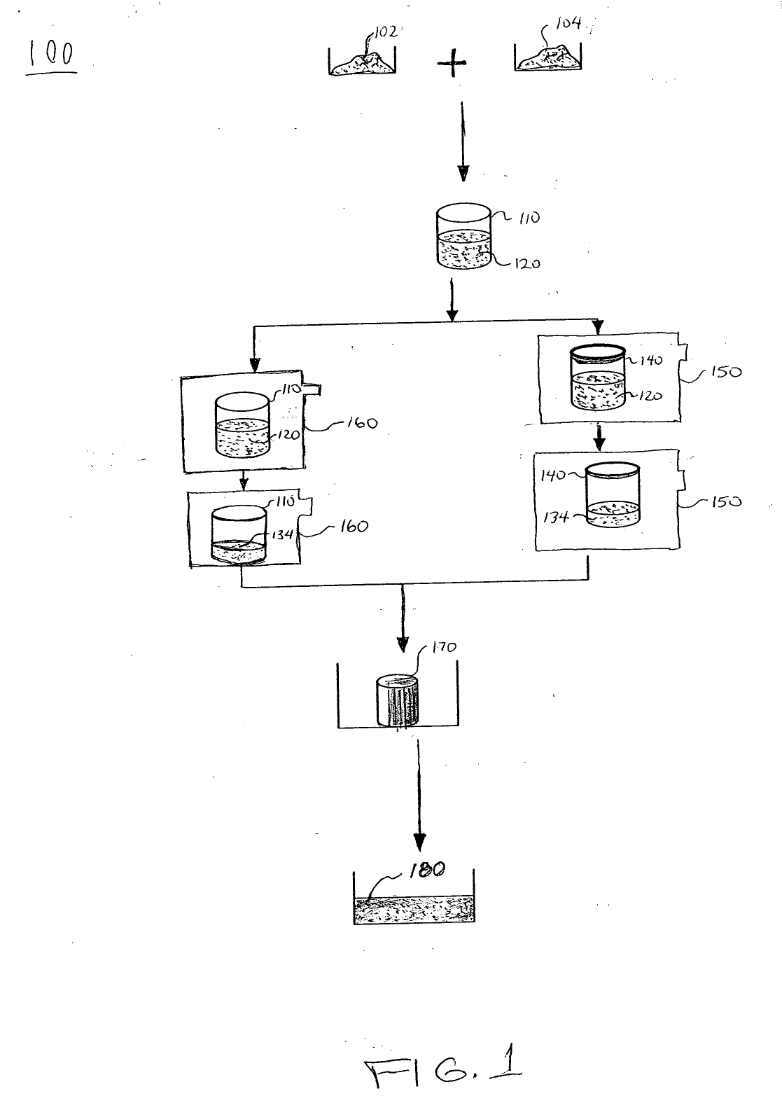

Turning to FIG. 1, a schematic flow chart of a melt mixing process 100 of organic materials is shown. Initially, the organic materials are combined to form a mixture of organic materials 120. The organic materials include at least one host component 102 and at least one dopant component 104. Depending upon the application and functionality of the mixture of organic materials 120, the dopant component 104 may vary from 0.1 to 20% by weight of the total mixture weight. Organic powders used as a host component 102 in the present invention are Alq3, NPB and TBADN. Examples of some organic dopant components 104 used in this invention are DCJTP, Rubrene, OP31, DPQA and DBzR.

The next process step involves placing the mixture of organic materials 120 in a container 110 for mixing the organic materials in the molten state. The container 110 is made preferably from a glass like Pyrex®, quartz or a high-temperature metal like stainless steel, Ta, W, or Pt. In one embodiment, the mixture is placed in the container 110, and the container 110 is evacuated and sealed to form a sealed container or an ampoule 140. The ampoule 140 containing the mixture of organic materials 120 are disposed inside an air furnace 150 and heated until the mixture of organic materials 120 are melted. Typically, the air furnace temperature is operated in a range between 300 and 700° C. depending upon the melting temperatures of the host component 102 and dopant component 104.

During heating the organic materials are mixed to form a molten homogeneous mixture of organic materials 134. The air furnace 150 is rocked or rotated to promote mixing of the host component 102 and dopant component 104 to produce a molten homogeneous mixture of organic materials 134. The molten homogeneous mixture of organic materials 134 are solidified by mixing and cooling the molten homogeneous mixture of organic materials 134 to room temperature thereby forming a solidified homogeneous mixture of organic materials 170. The solidified homogenous mixture of organic materials 170 is removed from the container 110 and can be directly used in physical vapor deposition. Furthermore, the solidified homogeneous mixture of organic materials 170 can be pulverized to form a homogenous mixture of organic powder 180, which can be used in physical vapor deposition. The homogeneous mixture of organic powder 180 further can be compacted in a range of pressures between 3,000 to 20,000 pounds per square inch, into a pellet for physical vapor deposition.

Alternatively, as shown in FIG. 1, the mixture of organic materials 120 is placed in the container 110. The container 110 is not sealed but remains an open-ended container 110. The open-ended container 110 is then placed inside a vacuum furnace 160 and a reduced atmosphere is provided in a range of pressures between of 10⁻³ to 10⁻⁶ Torr. The open-ended container 110 is heated to a temperature in a range between 300 to 700° C., well above the melting points of the organic host component 102 and the organic dopant component 104. The vacuum furnace 160 melts the mixture of organic materials 120 in order to form the molten homogenous mixture of organic materials 134. During heating, the container 110 is rocked or rotated to promote mixing of the host component 102 and dopant component 104 to produce the molten homogenous mixture of organic materials 134.

The process next involves solidifying the molten homogeneous mixture of organic materials 134 by mixing and cooling to form a solidified homogeneous mixture of organic materials 170. The vacuum furnace 160 is then vented to atmospheric pressure and the solidified homogeneous mixture of organic materials 170 is removed. Furthermore, the solidified homogeneous mixture of organic materials 170 is pulverized to form the homogenous mixture of organic powder 180, for use in a physical vapor deposition chamber to form an emission layer on a structure, which will form a part of an OLED display. The homogeneous mixture of organic powder 180 further can be compacted in a range of pressures between 3,000 to 20,000 pounds per square inch, to form a pellet suitable for physical vapor deposition.

### WORKING EXAMPLE

Blue Emission Layer.

First, 2.0 grams of organic dopant component powder TBP and 8.0 grams of organic host component powder TBADN were placed in a 50 ml glass container, which was evacuated to approximately 10⁻³ Torr and the open end was sealed using a oxy-acetylene torch to form an ampoule. The ampoule was placed inside a rocking air furnace and the ampoule was heated to 550° C. The organic materials were melted and mixed in the rocking air furnace to form a molten mixture of organic materials. The molten mixture of organic materials was mixed and cooled to room temperature to solidify the homogeneous mixture of organic materials.

The ampoule was removed from the furnace and broken to retrieve the solidified, homogeneous mixture of organic materials, which was pulverized to produce a powder. The homogeneous mixture of organic powder was then compacted at a pressure of 5,000 pounds per square inch into a pellet. The compacted pellet was placed in a quartz boat and the pellet was heated from the top using a Ta heater according to the prior art described by S. Van Slyke et al, SID 2002 Digest, pp. 886-889, 2002, which is incorporated herein for reference. Several OLED displays having the following structure were formed on a glass substrate coated with an indium-tin oxide anode:
Hole injection layer: CFx. Thickness=5 nm
HTL: NPB. Thickness=75 nm
EML: TBADN+2% TBP. Thickness=: 20 nm
ETL: Alq3. Thickness=35 nm
Cathode: MgAg. Thickness=200 nm

Initially, five OLED displays were made wherein the EML was formed by using a compacted pellet weighing approximately 2.0 grams and other organic layers such as a HTL and an ETL were formed using organic materials and a top heated quartz boat. Another set of five OLED displays was made after one hour of continuous evaporation. The compacted pellet was heated continuously for approximately 200 minutes until the pellet was completely consumed and a set of five OLED displays were made at intervals of 30 minutes. A shutter during the continuous deposition process protected the substrates and the shutter was opened only when emission layers were deposited to form an OLED display

The average EL results of each set of five OLED displays are shown in Table 1. The OLED displays in group A denote the average performance of five OLED displays made at the beginning of the deposition process, OLED displays in group B denote the average performance of five displays made after 120 minutes of continuous deposition and OLED displays in group C denote the average EL performance of five OLED displays made after 180 minutes of deposition.

TABLE 1
EL results of blue OLED displays formed according to the invention.

| | EML | OLED | Drive | Luminance | |
|---|---|---|---|---|---|
| Experiment | Composition | displays | Voltage | Yield (cd/A) | CIEx, y |
| 1 | TBADN + | A | 7.1 V | 2.51 | 0.15, 0.20 |
| | 2% TBP | | | | |
| 2 | TBADN + | B | 7.0 V | 2.35 | 0.14, 0.19 |
| | 2% TBP | | | | |
| 3 | TBADN + | C | 6.8 | 2.40 | 0.14, 0.18 |
| | 2% TBP | | | | |

The experimental results summarized in Table 1 indicate that the EL characteristics such as drive voltage, luminance yield and color coordinates, CIEx,y of the blue emission layer formed according to the invention remained uniform throughout the entire length of the deposition process indicating that the composition of the organic materials which included 98% TBADN (host) and 2% TBP (dopant) remained unchanged.

The invention has been described in detail with particular reference to certain preferred embodiments thereof, but it will be understood that variations and modifications can be effected within the spirit and scope of the invention.

### Parts List

100 melt mixing process
102 host component
104 dopant component
110 container
120 mixture of organic materials
134 molten homogeneous mixture of organic materials
140 ampoule
150 air furnace
160 vacuum furnace
170 solidified homogeneous mixture of organic materials
180 homogeneous mixture of organic powders

1. A method for forming homogeneous mixture of powders of organic materials including at least one dopant component and one host component for use in thermal physical vapor deposition to produce an organic layer on a substrate for use in an organic light-emitting device, comprising:
a) combining organic materials, such materials including at least one dopant component and one-host component to form a mixture of organic materials;
b) placing the mixture of organic materials in a container;
c) sealing the container in a reduced pressure environment;
d) heating the organic materials in the container until the organic materials are melted;
e) mixing the organic materials to form a homogeneous mixture of organic materials;
f) solidifying the homogeneous mixture of organic materials; and
e) removing the solidified homogeneous mixture of organic materials from the container.

2 The method of claim 1 further including:
h) pulverizing the solidified homogeneous mixture of organic materials into a homogeneous mixture of organic powder; and
i) compacting the homogenous mixture of organic powder, to form a pellet suitable for thermal physical vaporization to produce an organic layer on a substrate for use in an organic light-emitting device.

3. The method of claim 1 wherein the amount of dopant component varies between 0.1 and 20% by weight of the total mixture.

4. The method of claim 1 wherein the solidifying in element (f) includes mixing and cooling the homogenous mixture of organic materials until the materials are solidified.

5. The method of claim 2 wherein the compaction of the homogeneous mixture of organic powder to form a pellet is compacted in a range of pressures between 3,000 and 20,000 pounds per square inch.

6. The method of claim 1 wherein heating is provided by an air furnace operating in a range of temperatures between 300 to 700° C.

7. The method of claim 1 wherein the container is formed from glass or metal.

8. The method of claim 7, wherein the container includes high temperature metals Ta, W or Pt.

9. The method of claim 1 wherein the melting and heating includes placing the sealed container in a rotating air furnace.

10. The method of claim 1 wherein the reduced pressure environment is a pressure in a range of 10⁻¹ to 10⁻³ Torr.

11. A method for forming homogeneous mixture of powders of organic materials including at least one dopant component and one host component for use in thermal physical vapor deposition to produce an organic layer on a substrate for use in an organic light-emitting device, comprising:
a) combining organic materials in a powder form having at least one host component and one donor component to form a mixture of organic materials;
b) placing the mixture of organic materials in an open ended container;
c) placing the open ended container inside a vacuum furnace;
d) heating the organic materials inside the vacuum furnace until they are melted;
e) mixing the organic materials to form a homogeneous mixture of organic materials.
f) solidifying the homogeneous mixture of organic materials;
g) removing the solidified homogeneous mixture of organic materials from the open ended container; and
h) pulverizing the solidified homogeneous mixture of organic materials into a homogeneous mixture of organic powder suitable for thermal physical vaporization to produce an organic layer on a substrate for use in an organic light-emitting device.

12. The method of claim 11 further including:
i) compacting the homogenous mixture of organic powder, to form a pellet suitable for thermal physical vaporization to produce an organic layer on a substrate for use in an organic light-emitting device.

13. The method of claim 11 wherein the amount of dopant component varies between 0.1 and 20% by weight of the total mixture.

14. The method of claim 11 wherein the solidifying in element (f) includes mixing and cooling the homogenous mixture of organic materials until the materials are solidified.

15. The method of claim 12 wherein the compaction of the homogeneous mixture of organic powder to form a pellet is compacted in a range of pressures between 3,000 and 20,000 pounds per square inch.

16. The method of claim 11 further includes providing a reduced pressure in a range of 10⁻³ to 10⁻⁶ Torr inside the vacuum furnace.

17. The method of claim 11 wherein the container is formed from glass or metal.

18. The method of claim 17, wherein the container includes high temperature metals Ta, W or Pt.

19. The method of claim 11 wherein the heating in element (d) includes placing the sealed container in a rotating vacuum furnace.

20. The method of claim 11 wherein heating is provided by a vacuum furnace operating in a range of temperatures between 300 to 700° C.
